(19) United States
(12) Patent Application Publication
(10) Pub. No.: US 2023/0417947 A1
(43) Pub. Date: Dec. 28, 2023

(54) METHOD OF REVERSING AQUIFER PARAMETER WITH SKIN EFFECT

(71) Applicant: STANTEC CONSULTING SERVICES INC., TAIWAN BRANCH (USA), Taipei City (TW)

(72) Inventors: Chih-Tse WANG, Taipei City (TW); Yu-Yun HSIEH, Taipei City (TW); Tai-Sheng LIOU, Taipei City (TW); Bo-Han LAI, Taipei City (TW); Hund-Der YEH, Taipei City (TW); Yen-Ju CHEN, Taipei City (TW)

(21) Appl. No.: 17/850,188

(22) Filed: Jun. 27, 2022

(51) Int. Cl. G01V 9/02; G01N 15/08

(52) U.S. Cl. CPC G01V 9/02; G01N 15/0826; G01N 15/0806

(57) ABSTRACT

A method of reversing aquifer parameter with skin effect is used for reversing an aquifer parameter of a monitoring well and a surrounding area thereof. The method includes steps of: performing a slug test on the monitoring well, and measuring a first water level change of the monitoring well by a water level meter; setting a parameter assembly having a plurality of hypothetical aquifer parameters; converting the hypothetical aquifer parameters through a programming language, and then respectively calculating a plurality of second water level changes; respectively calculating a plurality of function values through an objective function according to the first water level change and the second water level changes, and selecting one hypothetical aquifer parameter corresponding to one function value that meets a convergence condition from the function values; taking the hypothetical aquifer parameter that meets the convergence condition as the aquifer parameter.

### BACKGROUND

### Technical Field

The present disclosure relates to a method of reversing aquifer parameter, and more particularly to a method of reversing aquifer parameter with skin effect by a drawdown record of a slug test.

### Description of Related Art

The statements in this section merely provide background information related to the present disclosure and do not necessarily constitute prior art.

Please refer to FIG. 1, which shows a cross-sectional view of a monitoring well. The monitoring well 11 includes a wellhead 1, a well pipe 2, and a well screen 3, and a filter material is filled around the monitoring well 100 to form a well skin layer 4, and outside the well skin layer 4 is an aquifer 5. In order to maintain the well condition of the set groundwater quality monitoring well 100, its monitoring function can be continuously performed, and its service life can be extended. Therefore, according to the “Groundwater Quality Monitoring Well Maintenance and Management Reference Manual” published by the Environmental Protection Administration, monitoring well maintenance operations should include external inspection maintenance, internal function inspection, and internal function maintenance (the execution process is shown in FIG. 2). Internal function maintenance includes well condition evaluation, foreign matter removal, next well completion, next well completion effect evaluation, etc. The process is to first evaluate the well condition by in-well photography and slug test, and then perform foreign matter removal and next well completion operations based on the above evaluation results, and conduct well condition evaluation after next well completion to verify the effectiveness of the next well completion. The aforementioned next well completion operations usually use next well completion methods such as well brushing, jetting, or over-pumping, which usually perform correct steps and procedures according to the type of well skin effect.

In particular, the well skin effect means that there is an annular region (i.e., the well skin layer 4) between the well pipe 2 and the aquifer 5 with poor (or better) water permeability than that of the aquifer 5, and the well skin effect is divided into a positive skin effect and a negative skin effect. It is inferred that the formation of the positive well skin effect is due to the infiltration of drilling mud into the soil pores around the well during the well setting process, forming an annular area with poorer water permeability than the aquifer 5. The formation of the negative well skin effect is that during the well setup process, the filter material filled around the well or the water permeability around the well is increased due to excessive well flushing. Therefore, assuming that the monitoring well has a positive skin effect, jet flushing or other equivalent methods (such as shaking or back flushing) can be used for maintenance (see Table 1 for detailed maintenance method).

Table 1 shows the criteria for selecting an appropriate next well completion method based on the well skin effect.

| | next well completion method |
|---|---|
| well skin effect | and sequence |
| high formation permeability, | 1. well brush (brushing the well body |
| good return water from the | 3 to 5 times) |
| monitoring well, no well | 2. air jet (until there is no mud and |
| skin effect | sand in the water) |
| | 3. excessive pumping (to meet completion |
| | standards) |
| positive skin effect | 1. well brush (brushing the well body 3 |
| | to 5 times) |
| | 2. air jet (until there is no mud and |
| | sand in the water) |
| | 3. jet flushing or other methods with |
| | equivalent functions (such as oscillation |
| | or backwashing |
| | 4. excessive pumping (to meet completion |
| | standards) |
| poor formation permeability, | 1. well brush (brushing the well body 3 |
| poor monitoring well | to 5 times) |
| backwater, negative or no | 2. air jet (until there is no mud and |
| well skin | sand in the water) |
| | 3. excessive pumping (to meet the well |
| | completion standard), but if the water |
| | volume in the well is small and the |
| | return water is very slow, the excess |
| | pumping may not be implemented, and |
| | the well water only needs to be drained |

However, although the “Groundwater Quality Monitoring Well Maintenance and Management Reference Manual” provides guidelines for selecting the next well completion method, there is no method for determining the well skin effect. Therefore, when performing monitoring well maintenance operations, only the appearance of the monitoring well and the inside conditions of the well pipe 2 and the well screen 3 can be observed, but the characteristics of the aquifer 5 outside the well screen 3 cannot be grasped.

### SUMMARY

In order to solve the above-mentioned problems, a method of reversing aquifer parameter with skin effect is provided. The method is implemented by a drawdown record of a slug test. The method includes steps of: performing a slug test on the monitoring well, and measuring a first water level change of the monitoring well by a water level meter; setting a parameter assembly having a plurality of hypothetical aquifer parameters; converting the hypothetical aquifer parameters through a programming language, and then respectively calculating a plurality of second water level changes; respectively calculating a plurality of function values through an objective function according to the first water level change and the second water level changes, and selecting one hypothetical aquifer parameter corresponding to one function value that meets a convergence condition from the function values; taking the hypothetical aquifer parameter that meets the convergence condition as the aquifer parameter.

In one embodiment, the aquifer parameter includes an aquifer hydraulic conductivity coefficient, an aquifer water storage coefficient, a well skin hydraulic conductivity coefficient, a well skin water storage coefficient, and a well skin radius.

In one embodiment, the function values are acquired by the sum of squares of differences between the first water level change and the second water level changes.

In one embodiment, the function value is selected from the function values by a symbiotic organisms search algorithm that meets the convergence condition.

In one embodiment, the symbiotic organisms search algorithm comprises a mutualism algorithm, a commensalism algorithm, and a parasitism algorithm.

In one embodiment, the mutualism algorithm includes steps of: (a1) selecting a first function value and a second function value from the function values to perform a mutualism calculation so as to recalculate function values for the first function value and the second function value; (a2) selecting the one with the smaller value as a first selection function.

In one embodiment, the commensalism algorithm includes steps of: (b1) selecting a third function value and the first selection function to perform a commensalism calculation so as to substitute at least one value of the third function value for the corresponding value in the first selection function to recalculate function values; (b2) selecting the one with the smaller value as a second selection function.

In one embodiment, the parasitism algorithm includes steps of: (c1) adjusting a value in the second selection function and performing a parasitism calculation to generate a mutation function; (c2) comparing the second selection function and the mutation function, and selecting the one with the smaller value as a third selection function.

In one embodiment, the method further includes a step of: repeating steps (a1) to (c2) until all function values are calculated.

The main purpose and effect of the present disclosure is that the present disclosure utilizes the above-mentioned drawdown record of a slug test to inversely deduce aquifer parameters with skin effect, and then calculate the ratio of hydraulic conductivity between the aquifer and the well skin layer to determine the well skin effect of the monitoring well, thereby selecting the appropriate next well completion method to achieve the purpose of maintenance and management of the monitoring well.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 shows a cross-sectional view of a monitoring well.

FIG. 2 shows an execution flow of maintenance and management of a groundwater quality monitoring well.

FIG. 3 shows a flowchart of a method of a parameter reverse for an aquifer with skin effect according to the present disclosure.

FIG. 4A shows a flowchart of the method of the parameter reverse for the aquifer with skin effect using a symbiotic organisms search algorithm according to the present disclosure.

FIG. 4B shows a flowchart of the method of a mutualism algorithm of the symbiotic organisms search algorithm according to the present disclosure.

FIG. 4C shows a flowchart of the method of a commensalism algorithm of the symbiotic organisms search algorithm according to the present disclosure.

FIG. 4D shows a flowchart of the method of a parasitism algorithm of the symbiotic organisms search algorithm according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

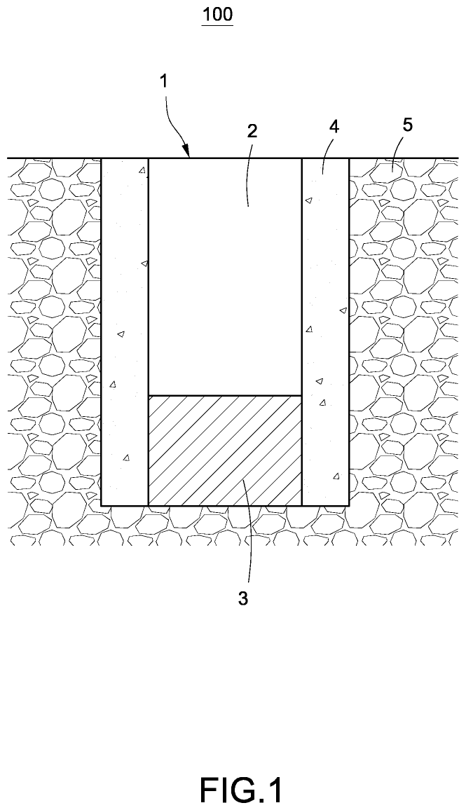

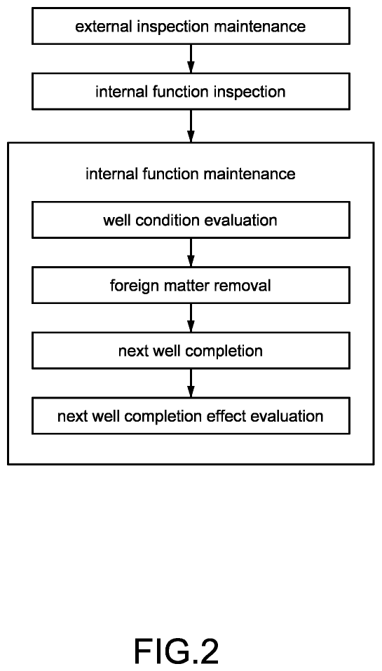

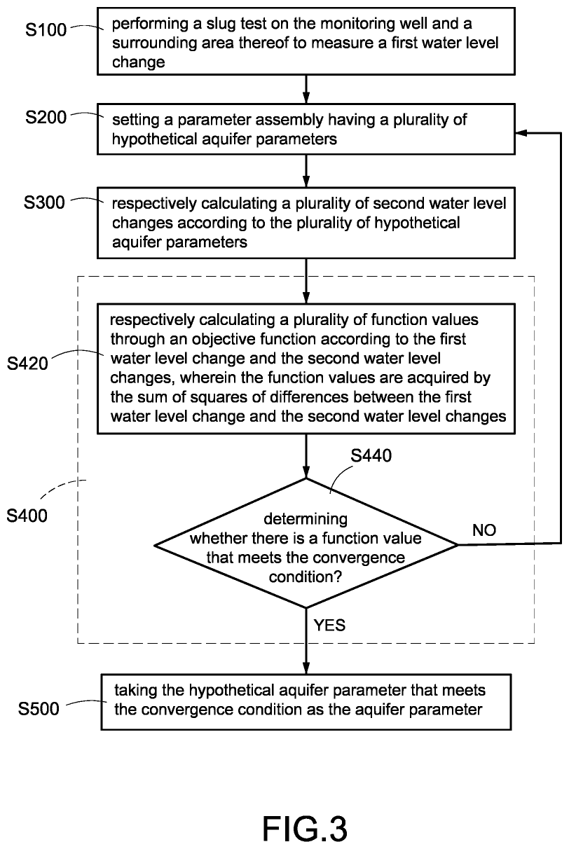

Please refer to FIG. 3, which shows a flowchart of a method of a parameter reverse for an aquifer with skin effect according to the present disclosure, and also refer to FIG. 1 and FIG. 2. In order to know the permeable property of the aquifer 5 near the monitoring well 100, it is usually estimated by using a drawdown record of a slug test, that is, the water level change of the monitoring well 100 in the slug test). The slug test includes the following steps. 1. assemble/collect data related the monitoring well, and the data include: wellhead 1 diameter, borehole diameter, aquifer thickness, well screen 3 length, drilling data and well string map, well setup data, confined aquifer, or uncompressed aquifer, etc. 2. measure groundwater level and well depth in the monitoring well. 3. put a water level meter (such as but not limited to a self-recording water level meter, etc.) into a proper position in the well (about 20 to 50 cm up from the bottom of the well). 4. start to sense and record groundwater pressure (or water head) with a water level meter. 5. put a water-drawing bucket (with a capacity of more than 2 liters or a water level difference of 20 cm or more) or a well block into the well until it is completely submerged in the water. 6. quickly take out the water-drawing bucket or the well block with the draw rope when the reading value of the water level meter is stable so that the groundwater in the well can be drained (drawdown) instantly. 7. recording changes in drawdown of groundwater level by the water level meter. 8. use software to analyze the data of the water level meter, calculate the hydraulic conductivity, and verify and compare with the hydrogeological sedimentary characteristics of the aquifer to confirm the correctness of the analysis data. 9. repeat the slug test and compare the analytical values. 10. perform equipment decontamination.

The method of reversing aquifer parameter with skin effect is mainly used to reverse the aquifer parameter in the monitoring well. The method includes steps of: performing a slug test on the monitoring well and a surrounding area thereof to measure a first water level change (S100) and inputting the record results into a computer. The surrounding area of the monitoring well 100 may cover several meters or tens of meters (i.e., the well skin layer 4 and the aquifer 5 are included). Specifically, the first water level change is mainly to measure the change (drawdown and recovery) of groundwater level through the slug test described above. Afterward, setting a parameter assembly having a plurality of hypothetical aquifer parameters (S200). Specifically, the aquifer parameter includes an aquifer hydraulic conductivity coefficient, an aquifer water storage coefficient, a well skin hydraulic conductivity coefficient, a well skin water storage coefficient, and a well skin radius. Therefore, the method of reversing aquifer parameter with skin effect mainly inversely deduces the above five values, when the actual influence of the well skin layer 4 cannot be known by observation, the inverse deduction of the actual well skin effect belongs to the positive well skin effect or the reverse well skin effect, and the effect of the well skin effect on the water level in the monitoring well 100.

Moreover, the hypothetical aquifer parameters are mainly based on the above known five values, and are based on the first water level change, and can be determined from the appearance or historical parameters of the monitoring well (wellhead 1 diameter, borehole diameter, aquifer thickness, well screen 3 length, drilling data and well string map, well setup data, confined aquifer or uncompressed aquifer, et), take out all possible values, and then put all possible values combination as the hypothetical aquifer parameters. Therefore, the parameter assembly includes 1 to N hypothetical aquifer parameters, and each hypothetical aquifer parameter includes at least the above five values (that is, each hypothetical aquifer parameter at least includes: the aquifer hydraulic conductivity coefficient, the aquifer water storage coefficient, the well skin hydraulic conductivity coefficient, the well skin water storage coefficient, and the well skin radius). The number of N is possible from several hundreds to tens of thousands, mainly based on the number of possible values.

Afterward, respectively calculating a plurality of second water level changes according to the plurality of hypothetical aquifer parameters (S300). Specifically, the hypothetical aquifer parameters need to be converted into a computer programming language through a programming language, and then a second water level change corresponding to each hypothetical aquifer parameter in the parameter assembly can be calculated through the operation of the software. The calculation of the second water level change can refer to the research of Yeh and Chen (2007), based on Moench and Hsieh (1985) to solve the analytical solution of the slug test, and the Laplace domain analytical solution formula for deriving the time-varying well water level is as follows:

$$\overline{h} = \frac{α γ [ {Δ}_{1} {K}_{0} ( q β ) - {Δ}_{2} {I}_{0} ( q β ) ]}{{c}_{1} {Δ}_{1} - {c}_{2} {Δ}_{2}} \qquad ( 1 )$$

$${Δ}_{1} = α {I}_{0} ( q β {r}_{s} ) {K}_{1} ( q {r}_{s} ) + β {I}_{1} ( q β {r}_{s} ) {K}_{0} ( q {r}_{s} ) \qquad ( 2 )$$

$${Δ}_{2} = α {K}_{0} ( q β {r}_{s} ) {K}_{1} ( q {r}_{s} ) - β {K}_{1} ( q β {r}_{s} ) {K}_{0} ( q {r}_{s} ) \qquad ( 3 )$$

$${c}_{1} = αγ {pK}_{0} ( q β ) + β q {K}_{1} ( q β ) \qquad ( 4 )$$

$${c}_{2} = αγ {pI}_{0} ( q β ) - β {qI}_{1} ( q β ) \qquad ( 5 )$$

$$α = {k}_{2} / {k}_{1} \qquad ( 6 )$$

$$β = \sqrt{α \frac{{S}_{s 1}}{{S}_{s 2}}} \qquad ( 7 )$$

$$γ = \frac{{r}_{c}^{2}}{2 {r}_{w}^{2} {S}_{s 2} b} \qquad ( 8 )$$

$$q = \sqrt{p} \qquad ( 9 )$$

In which, h̅ is the Laplace domain analytical solution of the well water level (WWL), p is the Laplace variable, k₁ and Sₛ₁ are respectively the well skin hydraulic conductivity coefficient and the well skin water storage coefficient, k₂ and Sₛ₂ are respectively the aquifer hydraulic conductivity coefficient and the aquifer water storage coefficient, r_{w} is the well radius, r_{c} is the well casing radius, rₛ is the well skin radius, b is the aquifer thickness, is the WWL, Iₙ and Kₙ in the well at the beginning of the test, which are respectively the first and second modified Bessel functions, and the subscript n is the order of the Bessel function.

The programming language may be implemented by programming languages such as, but not limited to, Python language, C language, R language, etc. The present disclosure mainly converts the above formula and parameter assembly into computer programming language through the above-mentioned example programming language, and then calculates the second water level change corresponding to each set of hypothetical aquifer parameters through computer operation. In particular, the programming language uses the Python language as the best implementation, which has the advantages of easy to use and wide versatility. Afterward, respectively calculating a plurality of function values through an objective function according to the first water level change and the second water level changes, and selecting one hypothetical aquifer parameter corresponding to one function value that meets a convergence condition from the function values (S400). In step (S400), the function values are acquired by the sum of squares of differences between the first water level change and the second water level changes (S420). Afterward, it is determined whether there is a function value that meets the convergence condition (S440). If step (S440) finds a function value that can meet the convergence condition, it means that the hypothetical aquifer parameter corresponding to the function value is correct. Therefore, taking the hypothetical aquifer parameter that meets the convergence condition as the aquifer parameter (S500) to determine the well skin effect of the monitoring well 100, and an appropriate next well completion method is selected to achieve the purpose of maintenance and management of the monitoring well 100. If the determination of step (S440) is “No”, the process returns to step (S200) to reset the parameter assembly.

The main purpose and effect of the present disclosure is that the present disclosure utilizes the above-mentioned drawdown record of a slug test to inversely deduce aquifer parameters with skin effect, and then calculate the ratio of hydraulic conductivity between the aquifer 5 and the well skin layer 4 to determine the well skin effect of the monitoring well 100, thereby selecting the appropriate next well completion method to achieve the purpose of maintenance and management of the monitoring well 100.

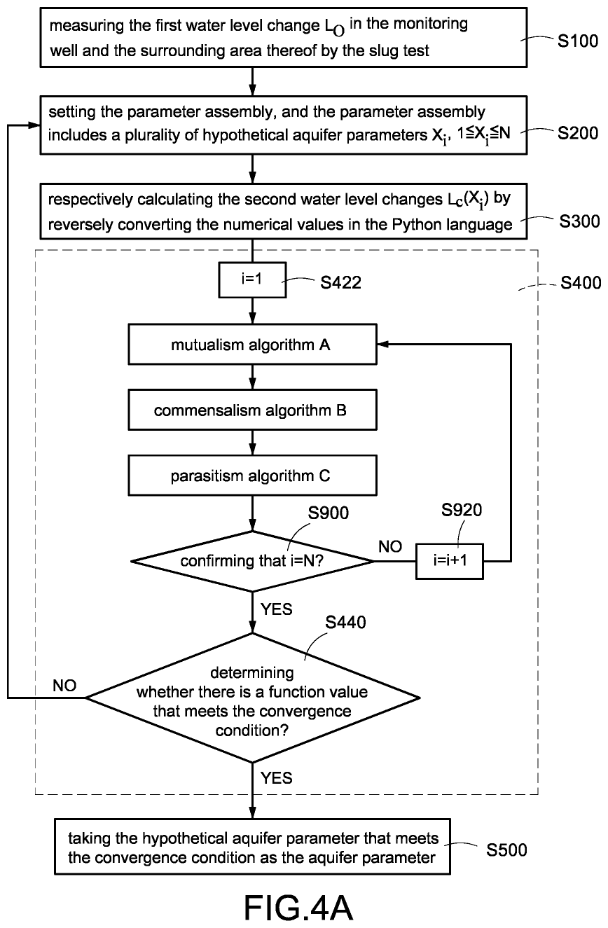

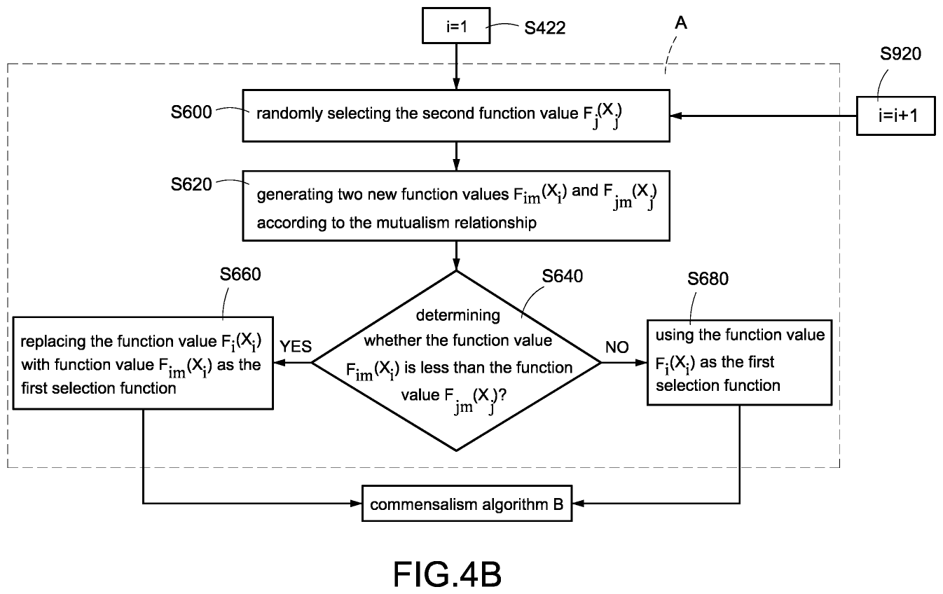

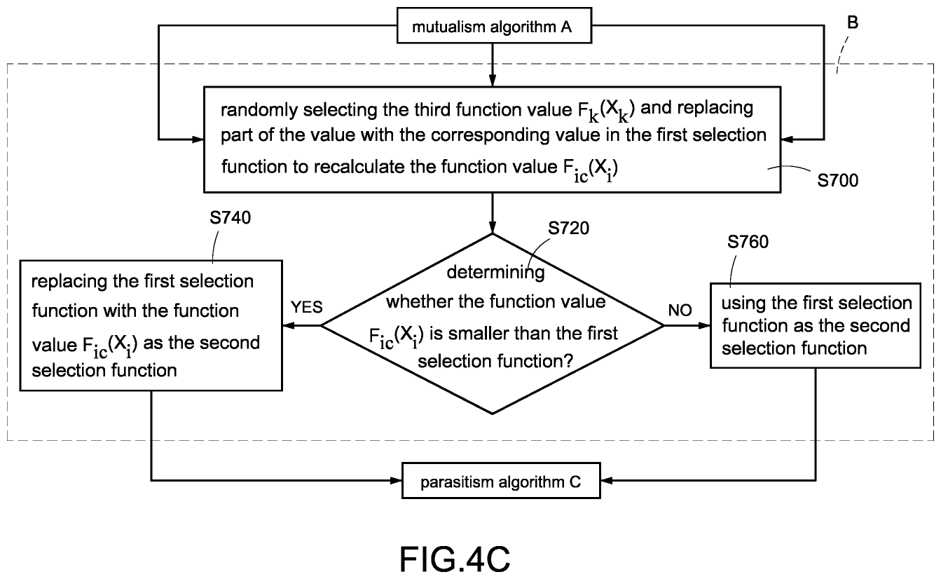

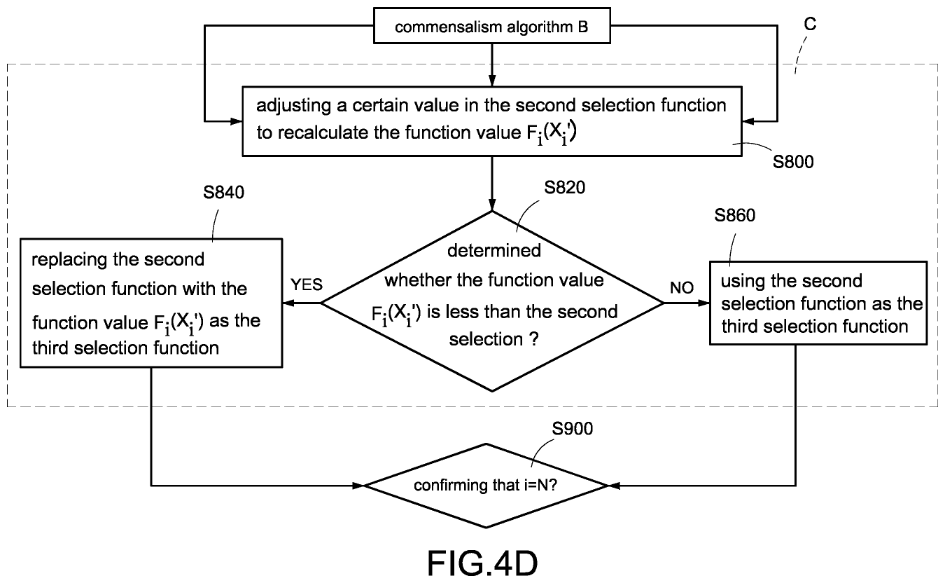

Please refer to FIG. 4A, which shows a flowchart of the method of the parameter reverse for the aquifer with skin effect using a symbiotic organisms search algorithm according to the present disclosure, please refer to FIG. 4B, which shows a flowchart of the method of a mutualism algorithm of the symbiotic organisms search algorithm according to the present disclosure, please refer to FIG. 4C, which shows a flowchart of the method of a commensalism algorithm of the symbiotic organisms search algorithm according to the present disclosure, please refer to FIG. 4D, which shows a flowchart of the method of a parasitism algorithm of the symbiotic organisms search algorithm according to the present disclosure, and also refer to FIG. 1 to FIG. 3. The processes shown in FIG. 4A to FIG. 4D are the detailed steps of the process in FIG. 3. In step (S400), the symbiotic organisms search (SOS) algorithm may be used to select a function value that meets the convergence condition so as to produce aquifer parameter reverse technology for determining the well skin effect, but it is not limited to this. Specifically, the symbiotic organisms search algorithm is only an algorithm for extracting the best solution, and the preferred embodiment has the advantage of fast calculation speed. In other words, in addition to using the symbiotic organisms search algorithm, for example, but not limited to the genetic algorithm, the Gauss-Legendre algorithm, etc., the algorithm that can find the function value that meets the convergence condition should be embraced within the scope of the present disclosure. In particular, different algorithms may be slightly different from the main process structure of FIG. 3, but do not affect the determination of the main steps of the process.

Please refer to FIG. 4A to FIG. 4D, in step (S100), the first water level change Lo in the monitoring well and the surrounding area thereof is measured by the slug test. Afterward, in step (S200) of setting the parameter assembly, the parameter assembly includes a plurality of hypothetical aquifer parameters Xᵢ, 1≤Xᵢ≤N. Afterward, in step (S300), the second water level changes L_{c}(Xᵢ) are respectively calculated by reversely converting the numerical values in the Python language. Afterward, in step (S400), the plurality of function values is respectively calculated through an objective function according to the first water level change and the second water level changes, and selecting one hypothetical aquifer parameter corresponding to one function value that meets the convergence condition from the function values. The function values are acquired by the sum of squares of differences between the first water level change and the second water level changes. Afterward, after i=1 (S422), the main step of the symbiotic organisms search algorithm is entered. In which, i=1 means selecting the first function value (that is, the function value Fᵢ(Xᵢ) of i=1), and the symbiotic organisms search algorithm includes the mutualism algorithm A, the commensalism algorithm B, and the parasitism algorithm C.

In the mutualism algorithm A, another set of function values is randomly selected from the remaining function values (i.e., the second function value Fⱼ(Xⱼ) is randomly selected, in step (S600)) to perform mutualism algorithm calculation. The mutualism algorithm calculation mainly involves generating two new function values Fᵢₘ(Xᵢ) and Fⱼₘ(Xⱼ) according to the mutualism relationship (step S620), and then determining whether the function value Fᵢₘ(Xᵢ) is less than the function value Fⱼₘ(Xⱼ) (step S640). The detailed calculation method of the mutualism algorithm calculation is a technology well known to those skilled in the art, and will not be repeated here. When the determination in step (S640) is “Yes”, replacing the function value Fᵢ(Xᵢ) with function value Fᵢₘ(Xᵢ) as the first selection function (step S660) so as to enter into the commensalism algorithm B. On the contrary, the function value Fᵢ(Xᵢ) is used as the first selection function (step S680) so as to enter into the commensalism algorithm B.

In the commensalism algorithm B, randomly selecting the third function value (i.e., Fₖ(Xₖ)) and the first selection function (Fᵢ(Xᵢ) or Fᵢₘ(Xᵢ)) for the commensalism algorithm calculation. The commensalism algorithm calculation is mainly to replace part of the value (at least one) in the third function value Fₖ(Xₖ) with the corresponding value in the first selection function (Fᵢ(Xᵢ) or Fᵢₘ(Xᵢ)) to recalculate the function value F_{ic}(Xᵢ) (step S700). The detailed calculation method of the commensalism algorithm calculation is a technology well known to those skilled in the art, and will not be repeated here. Afterward, it is determined whether the function value F_{ic}(Xᵢ) is less than the first selection function (the function Fᵢ(Xᵢ) or Fᵢₘ(Xᵢ) selected in the preceding steps (step S720). When the determination in step (S720) is “Yes”, replacing the first selection function (the function Fᵢ(Xᵢ) or Fᵢₘ(Xᵢ) selected in the previous steps) with the function value F_{ic}(Xᵢ) as the second selection function (step S740) to enter the parasitism algorithm C. On the contrary, the first selection function (the function Fᵢ(Xᵢ) or Fᵢₘ(Xᵢ) selected in the preceding steps) is used as the second selection function (step S760) to enter the parasitism algorithm C.

In the parasitism algorithm C, randomly mutating (changing) a certain value in the second selection function (the function F_{ic}(Xᵢ), Fᵢ(Xᵢ) or Fᵢₘ(Xᵢ) selected in the previous steps), and perform parasitism algorithm calculation. The parasitism algorithm calculation is mainly to adjust a certain value in the second selection function (the function F_{ic}(Xᵢ), Fᵢ(Xᵢ) or Fᵢₘ(Xᵢ) selected in the previous steps) to recalculate the function value Fᵢ(Xᵢ′) (step S800). The detailed calculation method of the parasitism algorithm calculation is a technology well known to those skilled in the art, and will not be repeated here. Afterward, it is determined whether the function value Fᵢ(Xᵢ′) is less than the second selection function (the function F_{ic}(Xᵢ), Fᵢ(Xᵢ) or Fᵢₘ(Xᵢ) selected in the preceding steps) (step S820). If the determination in step (S820) is “Yes”, replacing the second selection function (the function F_{ic}(Xᵢ), Fᵢ(Xᵢ) or Fᵢₘ(Xᵢ) selected in the previous steps) with the function value Fᵢ(Xᵢ′) as the third selection function (step S840). On the contrary, using the second selection function (the function F_{ic}(Xᵢ), Fᵢ(Xᵢ) or Fᵢₘ(Xᵢ) selected in the previous steps) as the third selection function (step S860).

After completing the mutualism algorithm A, the commensalism algorithm B, and the parasitism algorithm C (refer to FIG. 4A), it is confirmed that i=N (S900). When i is not equal to N, it means that all function values (1 to N) have not been calculated using the symbiotic organisms search algorithm, so i=i+1 (S920), and go back to step (S600) to repeat the processes of steps S600 to S860. When i is equal to N, it means that all the function values (1 to N) have been calculated, so it is determined whether there are any function values that meet the convergence condition (S440). If there are function values in groups 1 to N that meet the convergence condition, the hypothetical aquifer parameter that meets the convergence condition is taken as the aquifer parameter (S500) to determine the well skin effect of the monitoring well 100, and an appropriate next well completion method is selected to achieve the purpose of maintenance and management of the monitoring well 100. If the determination of step (S440) is “No”, the process returns to step (S200) to reset the parameter assembly.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A method of reversing aquifer parameter with skin effect, configured for reversing an aquifer parameter of a monitoring well and a surrounding are thereof, the method comprising steps of:
performing a slug test on the monitoring well, and measuring a first water level change of the monitoring well by a water level meter,
setting a parameter assembly having a plurality of hypothetical aquifer parameters,
converting the hypothetical aquifer parameters through a programming language, and then respectively calculating a plurality of second water level changes,
respectively calculating a plurality of function values through an objective function according to the first water level change and the second water level changes, and selecting one hypothetical aquifer parameter corresponding to one function value that meets a convergence condition from the function values, and
taking the hypothetical aquifer parameter that meets the convergence condition as the aquifer parameter.

2. The method of reversing aquifer parameter with skin effect as claimed in claim 1, wherein the aquifer parameter comprises an aquifer hydraulic conductivity coefficient, an aquifer water storage coefficient, a well skin hydraulic conductivity coefficient, a well skin water storage coefficient, and a well skin radius.

3. The method of reversing aquifer parameter with skin effect as claimed in claim 1, wherein the function values are acquired by the sum of squares of differences between the first water level change and the second water level changes.

4. The method of reversing aquifer parameter with skin effect as claimed in claim 1, wherein the function value is selected from the function values by a symbiotic organisms search algorithm that meets the convergence condition.

5. The method of reversing aquifer parameter with skin effect as claimed in claim 4, wherein the symbiotic organisms search algorithm comprises a mutualism algorithm, a commensalism algorithm, and a parasitism algorithm.

6. The method of reversing aquifer parameter with skin effect as claimed in claim 5, wherein the mutualism algorithm comprises steps of:
(a1) selecting a first function value and a second function value from the function values to perform a mutualism calculation so as to recalculate function values for the first function value and the second function value, and
(a2) selecting the one with the smaller value as a first selection function.

7. The method of reversing aquifer parameter with skin effect as claimed in claim 6, wherein the commensalism algorithm comprises steps of:
(b1) selecting a third function value and the first selection function to perform a commensalism calculation so as to substitute at least one value of the third function value for the corresponding value in the first selection function to recalculate function values, and
(b2) selecting the one with the smaller value as a second selection function.

8. The method of reversing aquifer parameter with skin effect as claimed in claim 7, wherein the parasitism algorithm comprises steps of:
(c1) adjusting a value in the second selection function and performing a parasitism calculation to generate a mutation function, and
(c2) comparing the second selection function and the mutation function, and selecting the one with the smaller value as a third selection function.

9. The method of reversing aquifer parameter with skin effect as claimed in claim 8, further comprising a step of:
repeating steps (a1) to (c2) until all function values are calculated.
